(19) United States
(12) Patent Application Publication
(10) Pub. No.: US 2013/0100655 A1
(43) Pub. Date: Apr. 25, 2013

(54) Led memorial light

(71) Applicant: James S. Gerson, Kansas City, MO (US)

(72) Inventor: James S. Gerson, Kansas City, MO (US)

(21) Appl. No.: 13/317,549

(22) Filed: Oct. 21, 2011

(51) Int. Cl. F21L 4/00

(52) U.S. Cl. 362/191

(57) ABSTRACT

An LED light source, a battery(ies) and a control switch which are electrically connected and rigidly connected within an LED tea light assembly, which assembly is gravitationally connected to a holder. A stake is rigidly connected with the holder, which allows installation into non-compacted earth, gravel, small stone or bored hole of a diameter slightly larger than that of the stake.

### RELATED APPLICATIONS

The present application is related to U.S. Pat. No. 4,787,017, issued Nov. 22, 1988, by Vrettos, included by reference herein.

The present application is related to U.S. Pat. No. 5,255,170, issued Nov. 19, 1993, by Plamp et al., included by reference herein.

The present application is related to U.S. Pat. No. 5,564,816, issued Oct. 15, 1996, by Arcadia et al., included by reference herein.

The present application is related to U.S. Pat. No. 6,132,054, issued Oct. 17, 2000, by Rogers et al., included by reference herein.

The present application is related to U.S. Pat. No. 6,234,652, issued May 22, 2001, by Tang, included by reference herein.

The present application is related to U.S. Pat. No. 6,364,503, issued Apr. 2, 2002, by Wenzel et al., included by reference herein.

The present application is related to U.S. Pat. No. 7,125,138, issued Oct. 24, 2006, by Reinmann, included by reference herein.

### FIELD OF THE INVENTION

The invention generally relates to decorative lights and, more specifically, to an LED tea light assembly resting in a holder with an integrated stake suitable for placement near and illumination of graveside, roadside or other memorial sites.

### BACKGROUND OF THE INVENTION

Illumination of graveside, roadside or other memorial sites is often desired by the owner, sponsor, curator, etc. Such illumination is often cost prohibitive. A power source is often not readily available. Solar power may be precluded by shade and cloudy climate at the memorial site. Skills required for installation of complex lighting systems may be cost prohibitive. Memorial sites may also be relatively unsecure, making expensive lighting solutions costly targets for theft or vandalism.

An object of the invention is to provide a lamp as mentioned at the beginning, which is reliable, resistant inmost environments, watertight, and having low production costs.

A special object of the invention is to provide a lamp of this kind which can also be easily installed by pressing the holder and stake into non-compacted earth, gravel, small stone or bored hole of a diameter slightly larger than that of the stake.

A further object is to provide a lamp of this kind which can also be easily moved to accommodate changing decorative elements around a memorial.

### SUMMARY OF THE INVENTION

In accordance with the present invention, there is provided an LED light source, a battery(ies) and a control switch which are electrically connected. The reliability, wear life and corrosion resistance of the LED light source and electrically connected elements are increased by these electrically connected elements also being rigidly integrated into an LED tea light assembly. The LED light source may be flickering or steady-on. The control switch may or may not be electrically connected to a light sensor and/or a timer, also rigidly integrated into an LED tea light assembly, allowing illumination of the holder and immediate area during darkness (i.e., diminished external light) or for a set or variable (switch-selected) number of hours after darkness is detected by the light sensor. The holder may have one or more holes to allow rain, condensation and/or other liquids to flow out, preventing leakage into and corrosion of the electrically connected elements. The holder may be in two pieces with a top piece threaded or snap-connected to a bottom piece, the top piece serving as a waterproof or water resistant cover for the LED tea light assembly resting in the bottom piece. A stake is rigidly connected with the holder, which allows easy installation by grasping the stake and pushing the pointed end of the stake into non-compacted earth, gravel, small stone or bored hole of a diameter slightly larger than that of the stake.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front detail view of an LED memorial light.

For purposes of clarity and brevity, like elements and components will bear the same designations and numbering throughout the FIGURE.

### DESCRIPTION OF THE PREFERRED EMBODIMENT

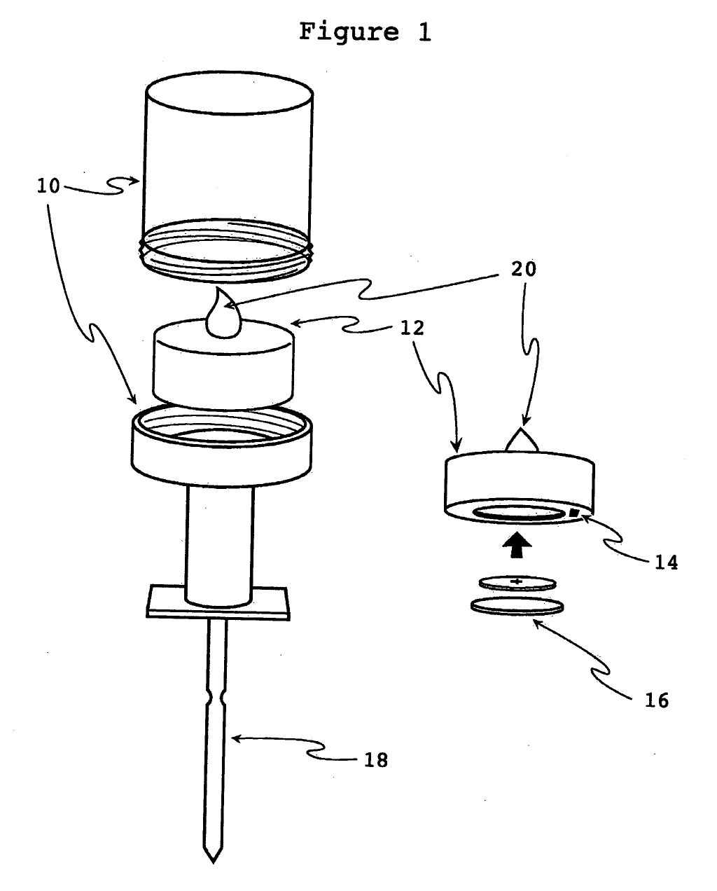

FIG. 1 is a front detail view of an LED tea light assembly 12 and holder 10 with rigidly connected stake 18. The LED tea light assembly 12 is comprised of an LED light source 20, a battery(ies) 16 and a control switch 14 which are electrically connected. The reliability, wear life and corrosion resistance of the LED light source 20 and electrically connected elements are increased by the battery(ies) 16 and control switch 14 being located on the LED tea light assembly 12. The LED light source 20 may be flickering or steady-on. The control switch 14 may or may not be electrically connected to a light sensor and/or a timer, allowing illumination of the LED light source 20 during darkness (i.e., diminished external light) or for a set or variable (switch-selected) number of hours after darkness is detected by the light sensor. The LED tea light assembly 12 rests within the holder 10. The holder 10 may have one or more holes to allow rain, condensation and/or other liquids to flow out, preventing leakage into and corrosion of the electrically connected elements. The holder 10 may be in two pieces with a top piece threaded or snap-connected to a bottom piece, the top piece serving as a waterproof or water resistant cover for the LED tea light assembly 12 resting in the bottom piece. A stake 18 is rigidly connected with the holder 10, which allows easy installation by grasping the stake 18 and pushing the pointed end of the stake 18 into non-compacted earth, gravel, small stone or bored hole of a diameter slightly larger than that of the stake 18.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An LED memorial light for illuminating graveside, roadside or other memorial sites, comprising:
means for an LED light source;
means for an LED tea light assembly rigidly connected with the LED light source;
means for a holder of the LED tea light assembly, gravitationally connected to said means for supporting the LED light source;
means for a control switch, electrically connected to said means for controlling power for illumination; and
means for battery(ies), electrically connected to said means for powering illumination;
means for securing a stake, rigidly connected to said means for supporting the LED light source.

2. The LED memorial light in accordance with claim 1, wherein said means for supporting the LED light source comprises an LED tea light assembly gravitationally connected to a holder of the LED tea light assembly, which holder is rigidly connected to a stake.

3. The LED memorial light in accordance with claim 1, wherein said means for illumination comprises an LED light source.

4. The LED memorial light in accordance with claim 1, wherein said means for controlling power for illumination comprises a control switch.

5. The LED memorial light in accordance with claim 1, wherein said means for powering illumination comprises a battery(ies).

6. The LED memorial light in accordance with claim 1, wherein said means for supporting the LED light source comprises a holder rigidly connected to a stake.

7. An LED memorial light for illuminating graveside, roadside or other memorial sites, comprising:
an LED tea light assembly, for securing the LED light source and electrically connected elements;
an LED tea light assembly, for illumination, gravitationally connected to a holder;
a control switch, for controlling illumination, electrically connected to said LED light source;
a battery(ies), for powering illumination, electrically connected to said control switch, and electrically connected to said LED light source; and
a stake, for securing the LED memorial light, rigidly connected to said holder.
